(19) United States
(12) Patent Application Publication
(10) Pub. No.: US 2004/0256817 A1
(43) Pub. Date: Dec. 23, 2004

(54) Tool caddy

(76) Inventor: Peter A. Sandoval, Chimayo, NM (US)

Correspondence Address: Stephen R. Greiner, Esquire, GREINER LAW OFFICES, P.C., Suite 110, 6701 Democracy Blvd., Bethesda, MD, 20817, US

(21) Appl. No.: 10/893,940

(22) Filed: Jul. 20, 2004

Related U.S. Application Data
(63) Continuation-in-part of application No. 10/255,687, filed on Sep. 27, 2002, now abandoned.

(51) Int. Cl. B62B 1/00

(52) U.S. Cl. 280/47.26

(57) ABSTRACT

A tool caddy for use with a hand truck having a pair of uprights and carrying a trashcan. The tool caddy includes a pair of articulated arms for engaging and supporting the sides of the trashcan. Each arm has a fixed inner portion with a clasp for releasable securement to an upright of the hand truck. A movable outer portion is positioned adjacent the fixed inner portion and has a free end remote from said the inner portion. A hinge joins the fixed inner portion to the movable outer portion. A flexible tether releasably connects the free end of each movable outer portion together. A tool retainer is secured to each of the articulated arms.

### CONTINUING APPLICATION INFORMATION This application is a continuation-in-part of the application Ser. No. 10/255,687, filed Sep. 27, 2002, now abandoned.

### FIELD OF THE INVENTION

The present invention relates generally to hand-propelled, wheeled vehicles and, more particularly, to plural load supports used therewith.

### BACKGROUND OF THE INVENTION

Gardeners have long used trashcans to haul their tools and to collect debris. To further reduce their labors, many gardeners have taken to employing conventional hand trucks and wagons to move tool- and debris-filled trashcans over the ground. Special-purpose dollies have been proposed for the purpose of toting trashcans and long-handled garden tools like rakes, shovels and brooms, but these have not seen widespread acceptance or great commercial success.

Conventional hand trucks and wagons lack means for securing trashcans in place and for supporting gardening tools remote from a trashcan. Bungee cords are, thus, used to weakly secure a trashcan in place on a hand truck or wagon. Furthermore, gardening tools are often carried along with garden waste in a trashcan positioned on a hand truck or wagon. Unfortunately, tools that are small in size are sometimes buried in the waste, forgotten and discarded.

Special purpose dollies pose a number of problems for users. Perhaps their principal problem is that trashcans are more-or-less permanently secured thereto, making the emptying of accumulated trash and garden debris a time-consuming and burdensome task. Furthermore, these dollies cannot be converted to normal use whereby items other than trashcans and a few tools can be easily transported. Finally, these dollies are costly and cumbersome in their construction. One does not often see them in use.

### SUMMARY OF THE INVENTION

In light of the problems associated with the known products for hauling trashcans and gardening tools around a lawn or garden, it is a principal object of the invention to provide a tool caddy that can be selectively attached to a conventional hand truck such that, in an open configuration, a trashcan and a plurality of tools can be carried by the hand truck for ready use and, in a collapsed configuration, the hand truck can be employed in a normal manner to transport items of any sort.

It is another object of the invention to provide a tool caddy of the type described that permits a trashcan to be easily attached and detached from the hand truck to which the tool caddy is mounted. Thus, scooping materials into such a trashcan or dumping materials from the trashcan can be accomplished in an unencumbered manner, free of a hand truck. Any tools carried by the tool caddy need not be detached therefrom to attach or detach the trashcan.

It is a further object of the invention to provide a tool caddy of the type described that can be universally mounted upon hand trucks of many different makes and models. Mounting of the tool caddy can be accomplished with minimal instruction and without tools of any sort. The tool caddy can also be used with trashcans of varied design.

It is an object of the invention to provide improved elements and arrangements thereof in a tool caddy for the purposes described which is lightweight in construction, inexpensive to manufacture, and dependable in use.

Briefly, the tool caddy in accordance with this invention achieves the intended objects by featuring a pair of articulated arms adapted to encircle a trashcan positioned on a hand truck. Each arm has a fixed inner portion with a clasp for releasable securement to an upright of the hand truck. A movable outer portion is positioned adjacent the fixed inner portion and has a free end remote from said the inner portion. A hinge joins the fixed inner portion to the movable outer portion. An elastomeric band releasably connects the free ends of the movable outer portions together and squeezes them against the sides of the trashcan. A number of tool retainers are secured to each of the articulated arms for supporting tools adjacent the trashcan.

The foregoing and other objects, features and advantages of the present invention will become readily apparent upon further review of the following detailed description of the preferred embodiment as illustrated in the accompanying drawings.

### BRIEF DESCRIPTION OF THE DRAWINGS

The present invention may be more readily described with reference to the accompanying drawings, in which:

FIG. 1 is a side view of a tool caddy in accordance with the present invention supporting a trashcan on a wheeled dolly.

FIG. 2 is a front view of the tool caddy, with portions broken away, on a wheeled dolly.

FIG. 3 is a top view of the tool caddy on a wheeled dolly.

FIG. 4 is a perspective view of a tool retainer used with the wheeled dolly.

FIG. 5 is a side view of the tool retainer of FIG. 4 with portions broken away to reveal details thereof.

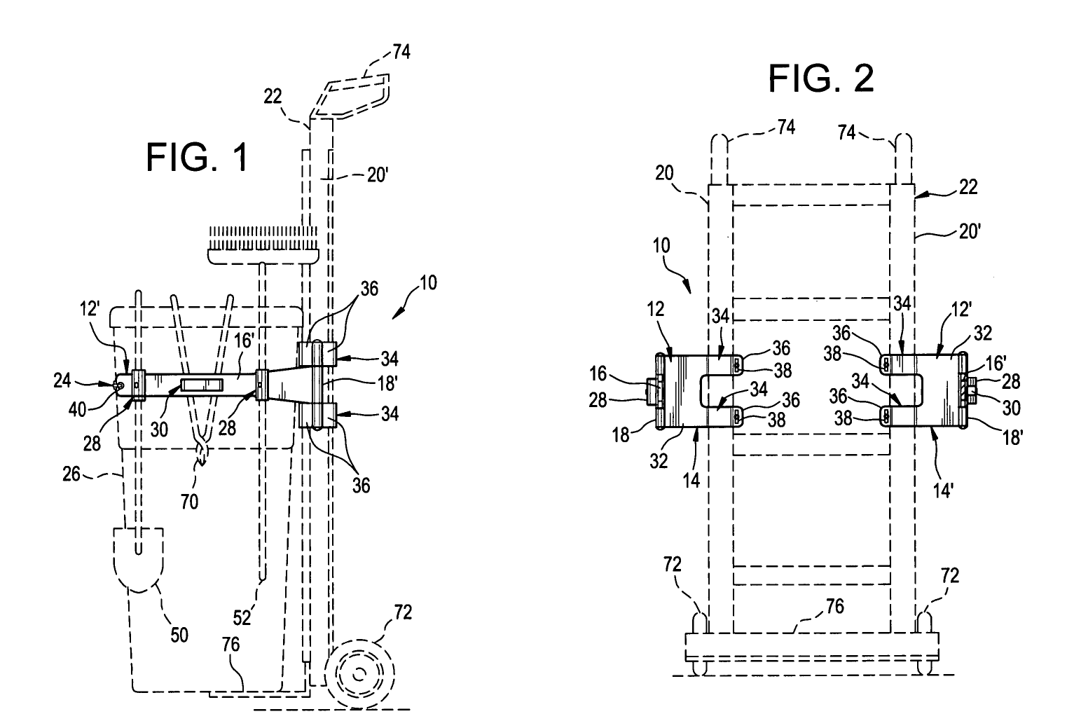

Similar reference characters denote corresponding features consistently throughout the accompanying drawings.

### DETAILED DESCRIPTION OF THE PREFERRED EMBODIMENT

Referring now to the FIGS., a tool caddy in accordance with the present invention is shown at 10. Tool caddy 10 includes a pair of articulated arms 12, 12′ each having a fixed inner portion 14, 14′ and a movable outer portion 16, 16′ joined together by a hinge 18, 18′. Each inner portion 14, 14′ is releasably affixed to an upright 20, 20′ of a hand truck 22. Outer portions 16, 16′, however, are releasably connected together by a flexible tether 24 so as to hold a trashcan 26 upon hand truck 22. Outer portions 16, 16′ are provided with a number of retainers 28 and 30 for suspending tools adjacent trashcan 26.

Each inner portion 14, 14′ has a base plate 32 from the inner end of which two clasps 34 extend. Each clasp 34 has a pair of resilient fingers 36 configured to encircle an upright 20, 20′ of hand truck 22. Threaded fasteners, i.e., wing nuts 38, pass through the free ends of fingers 36 and draw fingers 36 together to tightly grasp uprights 20, 20′. Opposite fingers 36, a hinge 18, 18′ is affixed to the outer end of each inner portion 14, 14′.

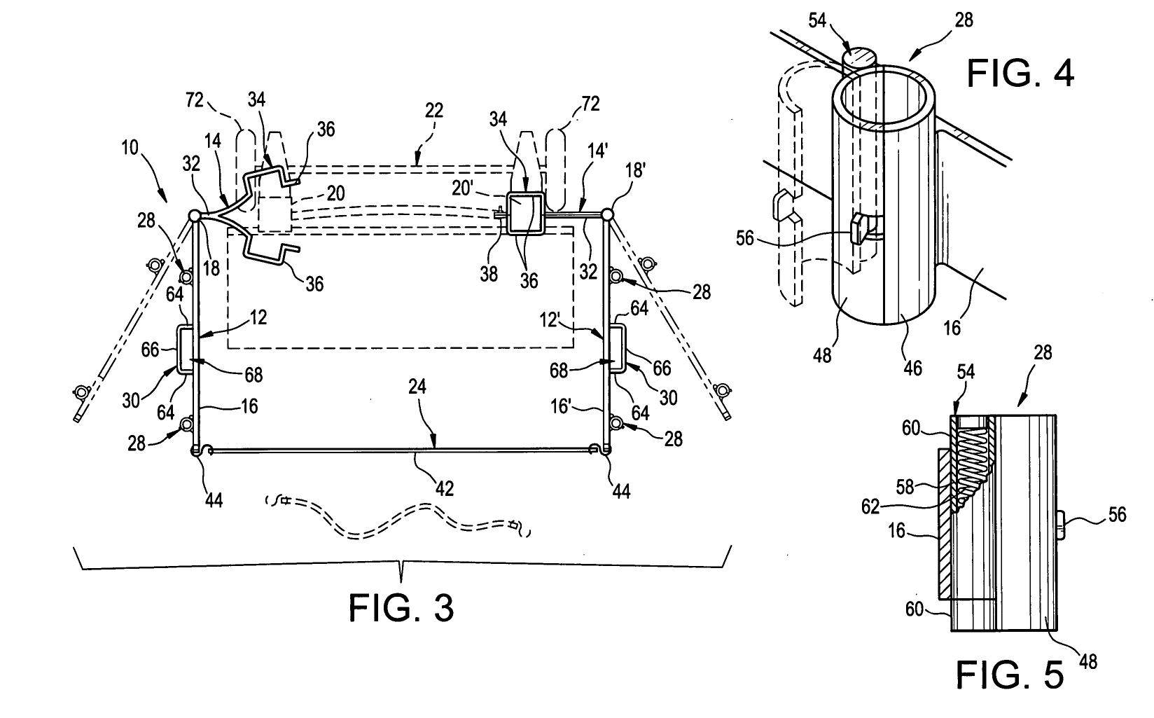

Each outer portion 16, 16′ comprises an elongated bar whose length is substantially equal to that of an adjacent side of trashcan 26. For increased stiffness and strength, the height of each outer portion 16, 16′ gradually increases toward its inner end being secured to a hinge 18, 18′. The outer end of each outer portion 16, 16′ is provided with a hole 40 for attaching flexible tether 24. During normal use, each outer portion 16, 16′ swings about a vertical axis established by hinge 18, 18′ as shown in FIG. 3.

Flexible tether 24 includes an elastomeric band 42 having hooks 44 secured to its opposite ends. Band 42 is somewhat shorter than that of the adjacent side of trashcan 26 so that it will be placed under tension when connecting arms 12, 12′ together. Hooks 44 are dimensioned such that they fit easily within holes 40 provided in arms 12, 12′.

A pair of tool retainers 28 is secured to each outer portion 16, 16′ in a spaced-apart relationship. Each of tool retainers 28 includes a pair of jaws 46 and 48 with C-shaped cross-sections that cooperate to encircle the handle of a shovel 50, a broom 52 or like tool. Preferably, each jaw 46 is affixed to an outer portion 16, 16′. Each jaw 48, however, is affixed to a spring hinge 54 that is, in turn, affixed to an outer portion 16, 16′ adjacent a jaw 48. A tab 56 extends outwardly from each jaw 48 and permits each jaw 48 to be easily pivoted away from a jaw 46 to open a tool retainer 28.

Each spring hinge 54 includes a tubular sleeve defined by a central tube 58 and a pair of end tubes 60 capable of rotational movement relative to central tube 58. Central tube 58 is affixed to an outer portion 16, 16′. End tubes 60, on the other hand, are affixed to a jaw 48. Positioned within each tubular sleeve is a wound spring 62. Preferably, spring 62 is attached to both central tube 58 and to at least one of the end tubes 60 in a manner that permits spring 62 to normally urge jaws 46 and 48 toward one another so that a tool can be grasped between them.

A tool retainer 30 is affixed to each outer portion 16, 16′ between tool retainers 28. Tool retainer 30 has a pair of opposed legs 64 joined by a crosspiece 66 in a C-shaped configuration. Legs 64 are welded, or otherwise joined, to an outer portion 16, 16′ and support crosspiece 66 as a distance from the associated outer portion 16, 16′. Into the slot 68 formed between crosspiece 66 and outer portion 16, 16′ can be positioned a tool such as loppers 70.

From the foregoing, it should be appreciated that mounting tool caddy 10 on hand truck 22 is straightforward. First, inner portions 14, 14′ are secured to hand truck 22 proximate the top of trashcan 26 by positioning fingers 36 around uprights 20, 20′ and tightening wing nuts 38 to hold clasps 34 in place. Next, trashcan 26 is positioned upon hand truck 22 and outer portions 16, 16′ are pivoted into engagement with the opposite sides of trashcan 26. Then, hooks 44 at the opposite ends of elastomeric band 42 are extended through holes 40 in outer portions 16, 16′ to tightly secure trashcan 26 upon hand truck 22. Although inner portions 14, 14′ are shown in the FIGS., to be positioned at right angles to outer portions 16, 16′ when the mounting of tool caddy 10 on hand truck 22 is concluded, outer portions 16, 16′ can be pivoted forward or back on uprights 20, 20′ to bring outer portions 16, 16′ into snug engagement with trashcans having dimensions different from those of trashcan 26.

Tools like shovel 50 and broom 52 are slipped into tool retainers 28 to secure such adjacent trashcan 26. When a tool is needed, it is simply pulled from the associated retainer 28 with jaws 46 and 48 opening as the biasing force of spring 62 is overcome. Other tools, like loppers 70, are simply inserted into, and withdrawn from, the top of slots 68 within tool retainers 30.

Should trashcan 26 become filled with debris during the course of its use, it is hauled on hand truck 22 with little likelihood of spilling (because joined arms 12, 12′ prevent trashcan upset) to a chosen spot for emptying. Then, flexible tether 24 is disengaged from arms 12, 12′ and moved to the broken line, flaccid position in FIG. 3. Next, arms 12, 12′ are pivoted to the broken line position of FIG. 3 where trashcan 26 is released from hand truck 22. Trashcan 26 is now be emptied in the normal manner. Any tools retained by retainers 28 and 30 need not be disengaged from tool caddy 10 to accomplish this task.

If it is desired that hand truck 22 be used to move a tree or shrub, trashcan 26 and tools 50, 52 and 70 would not be needed and would be set aside. To accomplish this, arms 12, 12′ would be pivoted rearwardly to a compact stowage position between the wheels 72 and handgrips and 74 of hand truck 22 so as to not engage the shrub (not shown). The shrub would now be positioned on the lifting platform 76 of hand truck 22 and moved without impediment from arms 12, 12′. Arms 12, 12′ always remain ready to be extended forwardly for future use in moving trashcan 26 and tools 50, 52 and 70.

While the invention has been described with a high degree of particularity, it will be appreciated by those skilled in the art that modifications may be made thereto. For example, tool retainers 28 and 30 can be replaced by any functional equivalent and may be slidably affixed to arms. Therefore, it is to be understood that the present invention is not limited to the sole embodiment described above, but encompasses any and all embodiments within the scope of the following claims.

I claim:

1. A tool caddy for use with a hand truck having a pair of uprights, said tool caddy comprising:
a pair of articulated arms each including:
a fixed inner portion having a clasp for releasable securement to an upright of the hand truck;
a movable outer portion positioned adjacent said fixed inner portion, said movable outer portion having a free end remote from said fixed inner portion; and,
a hinge joining said fixed inner portion to said movable outer portion;
a flexible tether releasably connecting said free end of each movable outer portion together; and,
a tool retainer secured to each of said articulated arms.

2. The tool caddy according to claim 1 wherein said clasp includes:
a pair of fingers configured to encircle an upright of the hand truck; and,
a threaded fastener penetrating said fingers and drawing said fingers together so as to tightly grasp an upright of the hand truck.

3. The tool caddy according to claim 1 wherein said flexible tether includes:
an elastomeric band having opposed ends; and
a pair of hooks each being fastened to a respective one of said opposed ends of said elastomeric band.

4. The tool caddy according to claim 1 wherein said tool retainer includes:
a first C-shaped jaw being affixed to one said movable outer portion;
a spring hinge being affixed to one said movable outer portion adjacent said first C-shaped jaw; and,
a second C-shaped jaw secured to said spring hinge and having an outwardly extending tab for manual movement of said second C-shaped jaw.

5. The tool caddy according to claim 1 wherein said tool retainer includes a pair of opposed legs joined together by a crosspiece in a C-shaped configuration.

6. A tool caddy for use with a hand truck having a pair of uprights and supporting a trashcan, said tool caddy comprising:
a pair of articulated arms each including:
a fixed inner portion having a pair of clasps for releasable securement to an upright of the hand truck;
a movable outer portion positioned adjacent said fixed inner portion, said movable outer portion having a free end remote from said fixed inner portion and a hole through said free end; and,
a hinge joining said fixed inner portion to said movable outer portion;
a flexible tether releasably connecting said free end of each movable outer portion together, said flexible tether including:
an elastomeric band having opposed ends; and
a pair of hooks each being fastened to a respective one of said opposed ends of said elastomeric band and each being adapted for releasable engagement with said hole in one said movable outer portion; and,
a plurality of tool retainers secured to each of said articulated arms.

7. The tool caddy according to claim 6 wherein each said movable outer portion has a length that is substantially equal to that of an adjacent side of the trashcan.

8. The tool caddy according to claim 6 wherein each said clasp includes:
a pair of fingers configured to encircle an upright of the hand truck; and,
a threaded fastener penetrating said fingers and drawing said fingers together so as to tightly grasp an upright of the hand truck.

9. The tool caddy according to claim 6 wherein one of said tool retainers includes:
a first C-shaped jaw being affixed to one said movable outer portion;
a spring hinge being affixed to one said movable outer portion adjacent said first C-shaped jaw; and,
a second C-shaped jaw secured to said spring hinge and having an outwardly extending tab for manual movement of said second C-shaped jaw.

10. The tool caddy according to claim 6 wherein one of said tool retainers includes a pair of opposed legs joined together by a crosspiece in a C-shaped configuration.

11. A tool caddy for use with a hand truck having a pair of uprights and supporting a trashcan, said tool caddy comprising:
a pair of articulated arms each including:
a fixed inner portion having a pair of clasps for releasable securement to an upright of the hand truck, each clasp including:
a pair of fingers configured to encircle an upright of the hand truck; and,
a threaded fastener penetrating said fingers and drawing said fingers together so as to tightly grasp an upright of the hand truck;
a movable outer portion having a length that is substantially equal to that of an adjacent side of the trashcan and being positioned adjacent said fixed inner portion, said movable outer portion having a free end remote from said fixed inner portion and a hole through said free end; and,
a hinge joining said fixed inner portion to said movable outer portion;
a flexible tether releasably connecting said free end of each movable outer portion together, said flexible tether including:
an elastomeric band having opposed ends; and
a pair of hooks each being fastened to a respective one of said opposed ends of said elastomeric band and each being adapted for releasable engagement with said hole in one said movable outer portion; and,
a plurality of tool retainers secured to each of said articulated arms, one of said tool retainers includes:
a first C-shaped jaw being affixed to one said movable outer portion;
a spring hinge being affixed to one said movable outer portion adjacent said first C-shaped jaw; and,
a second C-shaped jaw secured to said spring hinge and having an outwardly extending tab for manual movement of said second C-shaped jaw.

12. The tool caddy according to claim 11 wherein another of said tool retainers includes a pair of opposed legs joined together by a crosspiece in a C-shaped configuration.
